(19) United States
(12) Patent Application Publication
(10) Pub. No.: US 2009/0173342 A1
(43) Pub. Date: Jul. 9, 2009

(54) EMERGENCY BREATHING APPARATUS

(75) Inventor: Edwin Stuart Hamilton, Sudbury (GB)

Correspondence Address: Workman Nydegger;1000 Eagle Gate Tower, 60 East South Temple, Salt Lake City, UT, 84111, US

(73) Assignee: No Fuss Limited, Colchester (GB)

(21) Appl. No.: 12/299,595

(22) PCT Filed: Apr. 19, 2007
(86) PCT No.: PCT/GB2007/001410

§ 371 Date: Nov. 4, 2008

(30) Foreign Application Priority Data
May 5, 2006 (GB) 0608922.1
May 11, 2006 (GB) 0609320.7
Jul. 21, 2006 (GB) 0614527.0
Aug. 3, 2006 (GB) 0615436.3
Apr. 11, 2007 (GB) 0706987.5

(51) Int. Cl. A62B 7/00; A62B 9/06

(52) U.S. Cl. 128/202.13; 128/207.14

(57) ABSTRACT

An emergency breathing apparatus for skiers which is a device for attachment to an item of clothing, or in a ski pole or walking pole, which is adapted to enable a user to breathe in the event of being trapped in an avalanche. The emergency breathing apparatus comprises a conduit and a mouthpiece construction comprising a body member and a mouthpiece member. The mouthpiece member is in fluid communication with the conduit and is moveable between a compressed position at or near the body member and an extended position where it is located away from the body member, and allows a user to exhale through the conduit.

The present invention relates to an emergency breathing apparatus for skiers, in particular, a ski pole, walking pole or device for attachment to an item of clothing adapted to enable a user to breathe in the event of being trapped in an avalanche.

In the present application, where reference is made to skiers and skiing, any mountain user or activity where there is risk of an avalanche is intended.

Skiers, and in particular off-piste skiers, are often at risk of falling victim to avalanches. Avalanches occur when a large snow mass (or other material) is displaced and slides down the side of a mountain under the force of gravity. As snow is most prevalent in winter, these months cause the highest build up of snow and as such avalanches are more likely.

Unfortunately, good skiing conditions therefore often coincide with good avalanche conditions—loose snow is desirable for skiing but is also more prone to slippage; steep slopes are also desirable for skiing but also assist in the flow of a moving mass of snow.

Causes of avalanches include the composition of the terrain (how well the snow is retained), the composition of the snow (depth, crystal size, density) and weather conditions (wind, rain, snowfall, temperature). Predicting avalanches is therefore a difficult task and skiers must take precautions by ensuring they carry appropriate emergency equipment.

Avalanche cords consist of lengths of a brightly coloured cord which trail behind a skier. In the event of an avalanche, the cord would hopefully remain above the snow and indicate the position of a buried person. However, this relies on the person being buried within a depth allowing some of the cord to show, and also on a rescuer being able to spot the coloured cord against a vast expanse of white.

Beacons or beepers, which are avalanche transceivers, are generally carried by every person in a party. They emit a radio signal at 457 kHz, which can be detected by a receiver to locate someone who has been buried. The beacons can typically be switched from a transmit mode to a receive mode for this purpose.

Probes may also be carried, but are inefficient ways of locating buried persons unless some visual signs of a person being buried in a specific area are apparent. Measuring the depth of known buried persons allows rescuers to prioritise digging, with deeper persons generally left to last as shallower burials stand a greater chance of survival.

An article “Avalanche Survival Chances” by Markus Falk, Hermann Brugger and Liselotte Adler-Kastner (Nature, vol 368, page 21, 1994) details the survival probability of skiers as a function of the time buried under the snow. This falls from 92% at 15 minutes to only 30% at 35 minutes. This is representative of deaths caused by acute asphyxiation, i.e. those trapped without an air pocket.

Between 35 minutes and 90 minutes the survival probability is roughly constant but falls from 27% to only 3% at 130 minutes. The constant probability is due to skiers being trapped in an air pocket and protected from rapid hypothermia. The rapid decrease after 90 minutes is attributed to slow asphyxiation as oxygen in the air pocket runs out.

The emergency equipment cited herein generally assists in the locating of buried persons. However, prolonging the life of the buried person, by removing carbon dioxide, obviously increases their chances of being found alive.

Emergency equipment is available which allows avalanche victims to breathe while trapped under the snow, but these tend to be expensive, complex and bulky items. In any case, these represent additional items that users have to carry over and above the standard equipment.

It is therefore an object of the present invention to provide an emergency breathing apparatus for skiers trapped in an avalanche.

According to a first aspect of the present invention, there is provided an emergency breathing apparatus for skiers trapped in an avalanche, the emergency breathing apparatus comprising a conduit, the conduit comprising a substantially hollow channel, a proximal end and a distal end, the proximal end comprising one or more first apertures and the distal end comprising one or more second apertures and the substantially hollow channel being adapted to provide fluid communication between the one or more first apertures and the one or more second apertures.

According to a second aspect of the present invention, there is provided an emergency breathing apparatus for skiers trapped in an avalanche, the emergency breathing apparatus comprising a pole, the pole comprising a substantially hollow channel, a proximal end and a distal end, the proximal end comprising one or more first apertures and the distal end comprising one or more second apertures and the substantially hollow channel being adapted to provide fluid communication between the one or more first apertures and the one or more second apertures.

Preferably, the pole is a ski pole.

Alternatively, the pole is a walking pole.

A skier, for example, buried in snow may therefore use the ski pole or the conduit to breathe in the event that they are buried without a substantial air pocket. Additionally, a skier buried in an air pocket can attempt to prolong survival by expelling carbon dioxide (in exhaled breath) to a location outside of the air pocket. This also prevents the formation of an ice shield over the face of the skier which would rapidly lead to asphyxiation.

Preferably, the apparatus further comprises a one way valve adapted to restrict fluid flow in one direction through the hollow channel.

In addition to permitting removal of carbon dioxide from the surroundings, the one way valve may serve to prevent a skier from breathing in snow or water (from melted snow) which might otherwise cause respiratory problems.

Preferably, the one way valve is located in the hollow channel proximal to the one or more first apertures.

Alternatively, the one way valve is located in the hollow channel proximal to the one or more second apertures.

Preferably, the one way valve is a slit valve.

Preferably, the one or more second apertures are located at different longitudinal positions.

Preferably, the pole further comprises a handle, the handle comprising the one or more first apertures.

Preferably, the pole further comprises a basket adapted to restrict movement of the pole in a downwards direction relative to the proximal end, and located at or near to the one or more second apertures.

Preferably, the basket is located below the one or more second apertures relative to the proximal end.

The basket may therefore prevent snow from plugging the one or more second apertures when the pole is in use.

Optionally, the one way valve is located in the basket.

Optionally, the pole further comprises a retractable cover, moveable between a location covering the one or more second apertures and a location not covering the one or more second apertures.

Alternatively, the pole further comprises a removable cover positioned to cover the one or more second apertures.

Preferably, the pole further comprises a conduit located within the hollow channel and in fluid communication with the one or more first apertures.

Preferably, the conduit is also in fluid communication with the one or more second apertures, so as to provide fluid communication between the one or more first apertures and the one or more second apertures.

Preferably, the handle is removably attached to the pole.

Optionally, the pole is extendable.

Preferably, the conduit is extendable.

The handle may then be removed from the pole and brought towards the skier's mouth to facilitate breathing. Furthermore, if the pole is extendable the conduit may extend with the pole.

Optionally, the handle comprises a top section and a bottom section, the top section releasably attached to the bottom section.

Preferably, the handle comprises a quick release mechanism to operably release the top section from the bottom section.

Optionally, the handle comprises a hinge connected between the top section and the bottom section.

Preferably, the conduit is releasably retained within the handle while the top section is attached to the bottom section.

Preferably, the conduit is in a compressed position when retained within the handle.

Preferably, the conduit is resiliently biased toward an extended position.

Preferably, the conduit is adapted to move toward the extended position when the top section is released from the bottom section.

Optionally, the bottom section comprises a cavity adapted to house the conduit in the compressed position.

Preferably, the pole comprises a mouthpiece attached to the proximal end of the conduit.

Preferably, the mouthpiece comprises the one or more first apertures.

Optionally, the basket is adapted to comprise the one or more second apertures.

Preferably, the pole further comprises a whistle capable of producing an audible sound.

Preferably, the whistle is selectably actuable.

Preferably, the whistle is located at the proximal end of the pole.

Alternatively, the whistle is located at the distal end of the pole.

Optionally, the whistle is located between the one or more first apertures and the one or more second apertures.

According to a third aspect of the present invention, there is provided a mouthpiece construction for use with the conduit or the pole of the first or the second aspect, the mouthpiece construction comprising a body member and a mouthpiece member, the mouthpiece member moveable between a compressed position where it is located at or near the body member and an extended position where it is located away from the body member.

Preferably, the mouthpiece member is biased toward the extended position by means of a spring.

Preferably, the mouthpiece member is held in the compressed position by a releasable catch.

Preferably, the releasable catch is resiliently biased in a closed position where the mouthpiece member is in the compressed position.

Optionally, the releasable catch comprises a plate adapted to cooperate with a corresponding groove on the mouthpiece member.

Alternatively, the releasable catch comprises a circular clip adapted to cooperate with a corresponding groove on the mouthpiece member.

Optionally, the body member comprises a threaded portion.

Preferably, the mouthpiece construction further comprises a cap adapted to removably seal the mouthpiece member.

Optionally, the cap is adapted to be removable by biting.

Preferably, the mouthpiece construction further comprises an attachment means.

Preferably, the attachment means is adapted to locate on a pole.

The pole may be a ski pole or a walking pole.

Optionally, the attachment means comprises a threaded portion.

Alternatively, the attachment means is adapted to locate on or in an item of clothing.

According to a fourth aspect of the present invention, there is provided an item of clothing comprising a mouthpiece construction according to the third aspect in fluid communication with a conduit according to the first aspect, wherein the conduit extends substantially through the item of clothing.

Preferably, the item of clothing is a jacket.

Preferably, the mouthpiece construction is located at or near a collar of the jacket.

Alternatively, the mouthpiece construction is located at or near a wrist-cuff of the jacket.

Alternatively, the item of clothing is a pair of salopettes.

Preferably, the conduit comprises a one way valve located at a lower end of the item of clothing.

Alternatively, the conduit comprises a one way valve located at an upper end of the item of clothing.

Alternatively, the conduit comprises a connection means located at a lower end of the item of clothing, adapted for connection to a second item of clothing having a second conduit extending therethrough.

Preferably, the second item of clothing is selected from the group of trousers, leggings, shorts and salopettes.

Preferably, the second conduit comprises a one way valve located at a lower end of the second item of clothing.

Alternatively, the second conduit comprises a one way valve located at an upper end of the item of clothing.

The present invention will now be described by way of example only and with reference to the accompanying figures in which:

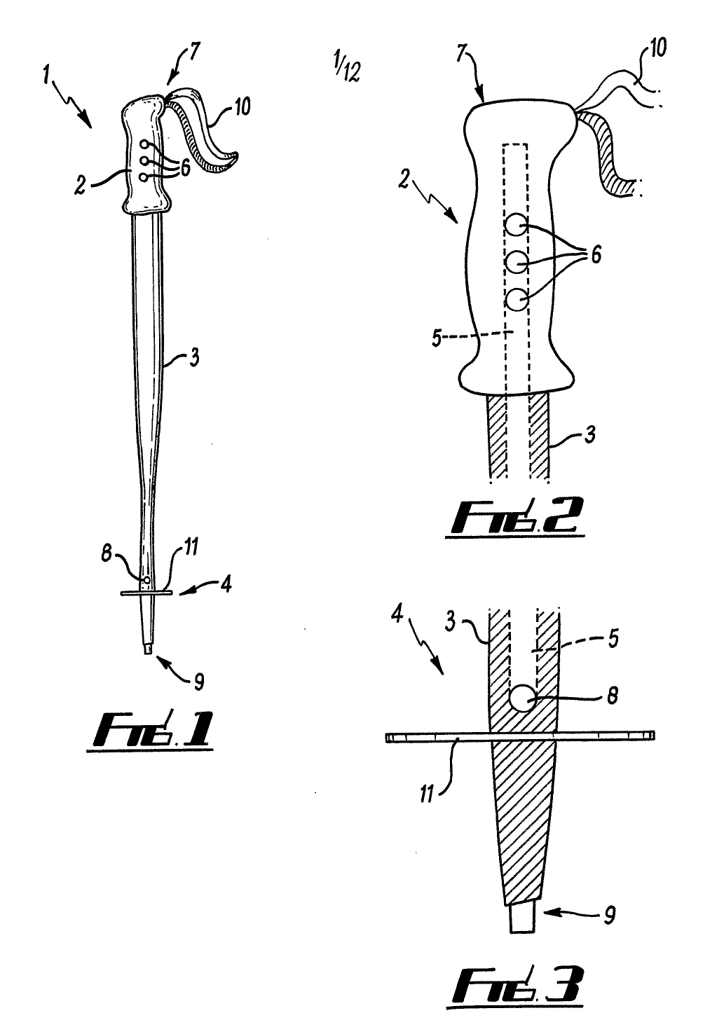

FIG. 1 illustrates in schematic form a ski pole in accordance with an aspect of the present invention;

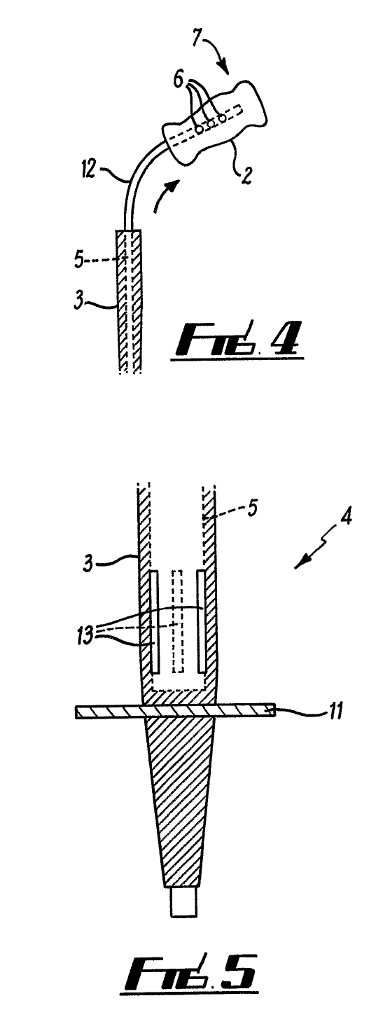

FIG. 2 illustrates in schematic form the handle of the ski pole of FIG. 1 in more detail, in accordance with an aspect of the present invention;

FIG. 3 illustrates in schematic form the tip section of the ski pole of FIG. 1 in more detail, in accordance with an aspect of the present invention;

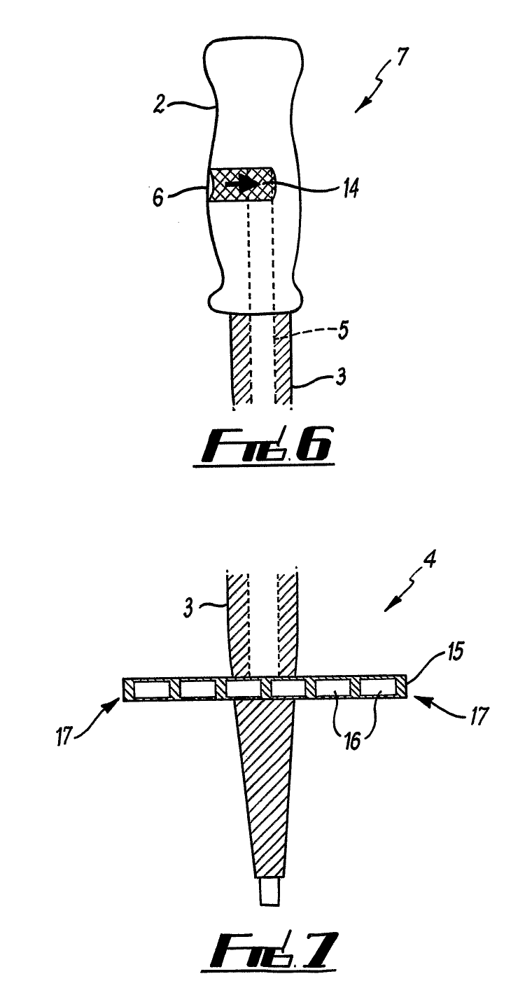

FIG. 4 illustrates in schematic form an alternative handle for a ski pole, comprising an extendable tube in accordance with an aspect of the present invention;

FIG. 5 illustrates in schematic form an alternative tip section for a ski pole, in accordance with an aspect of the present invention;

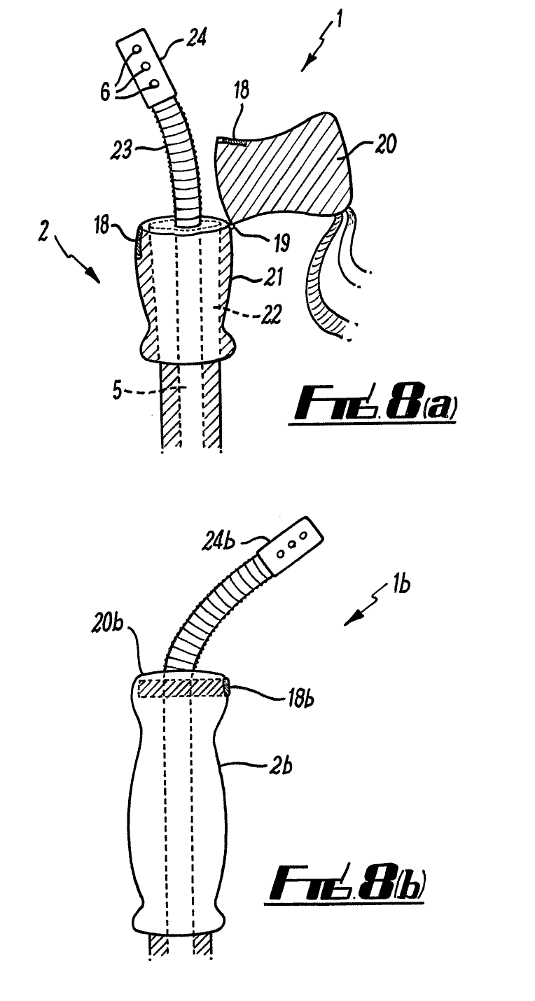

FIG. 6 illustrates in schematic form yet another alternative handle for a ski pole, comprising a one way valve in accordance with an aspect of the present invention;

FIG. 7 illustrates in schematic form yet another alternative tip section for a ski pole, comprising a modified basket in accordance with an aspect of the present invention;

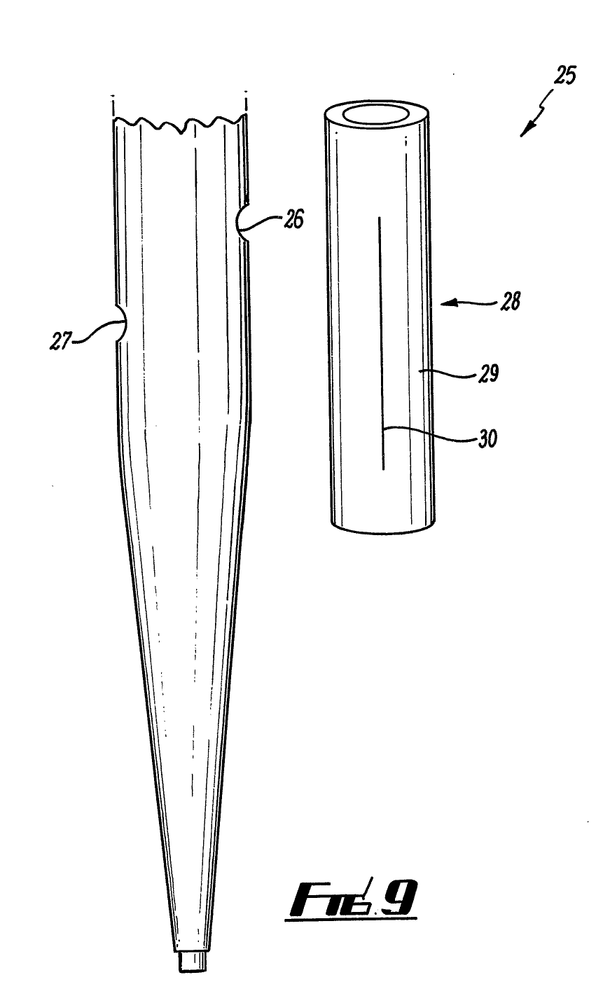

FIG. 8 illustrates in schematic form a further alternative handle for a ski pole, comprising a spring-loaded mouthpiece in accordance with an aspect of the present invention;

FIG. 9 illustrates in schematic form a further alternative tip section for a ski pole, comprising two longitudinally separated apertures and a one way valve in accordance with an aspect of the present invention;

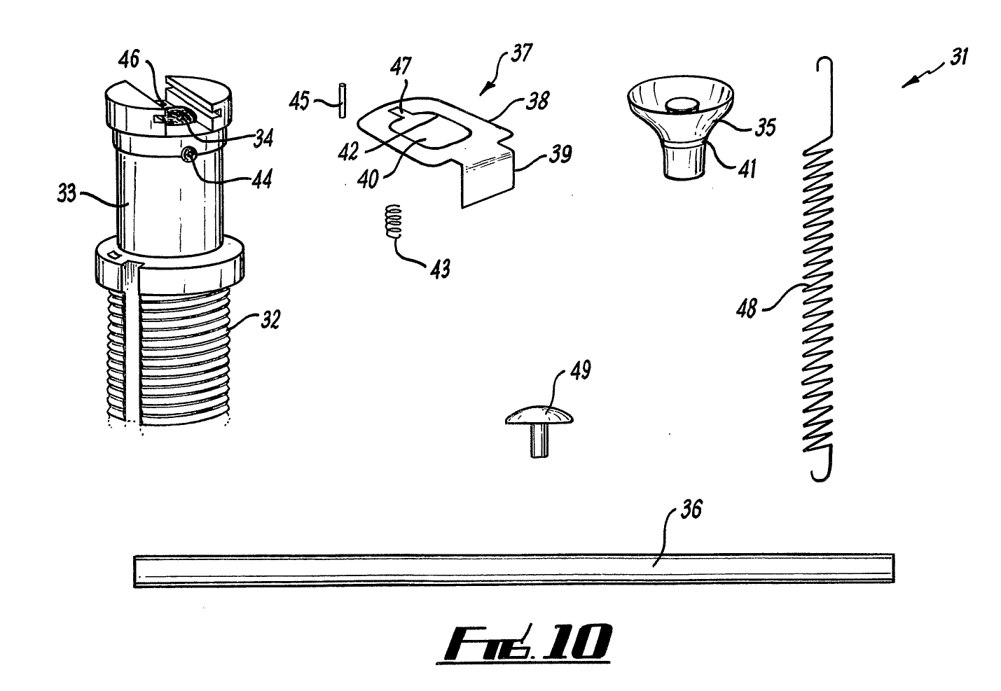

FIG. 10 illustrates in schematic form an exploded view of an alternative handle and mouthpiece in accordance with an aspect of the present invention;

FIG. 11 illustrates in schematic form an alternative mouthpiece in accordance with an aspect of the present invention;

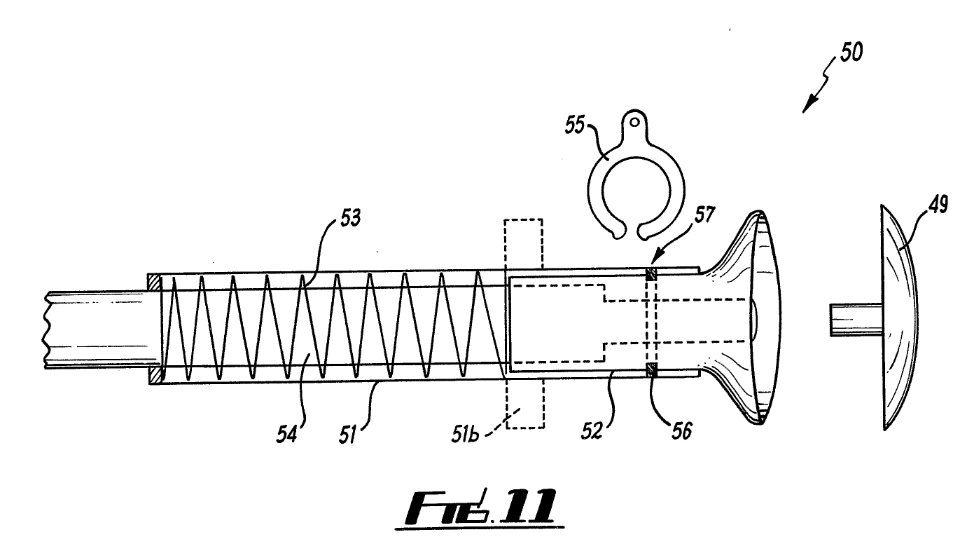

FIG. 12 and FIG. 12b illustrate in schematic form a jacket with a mouthpiece and a breathing tube disposed through the jacket in accordance with an aspect of the present invention;

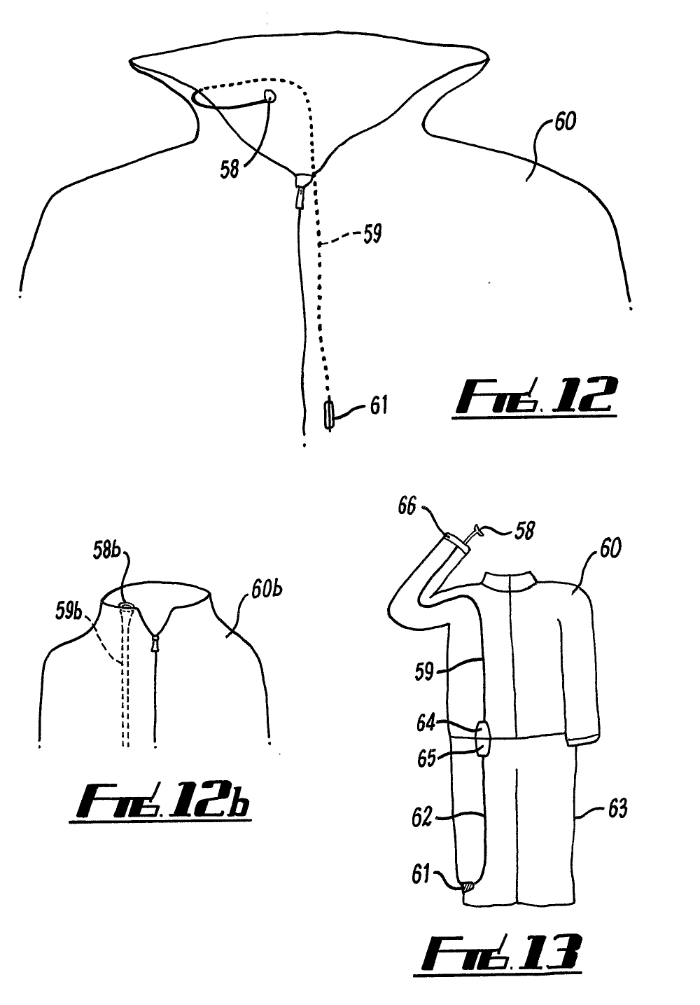

FIG. 13 illustrates in schematic form two connected breathing tubes located through a jacket and a trouser in accordance with an aspect of the present invention;

FIG. 14 illustrates in schematic form an alternative mouthpiece construction in accordance with an aspect of the present invention;

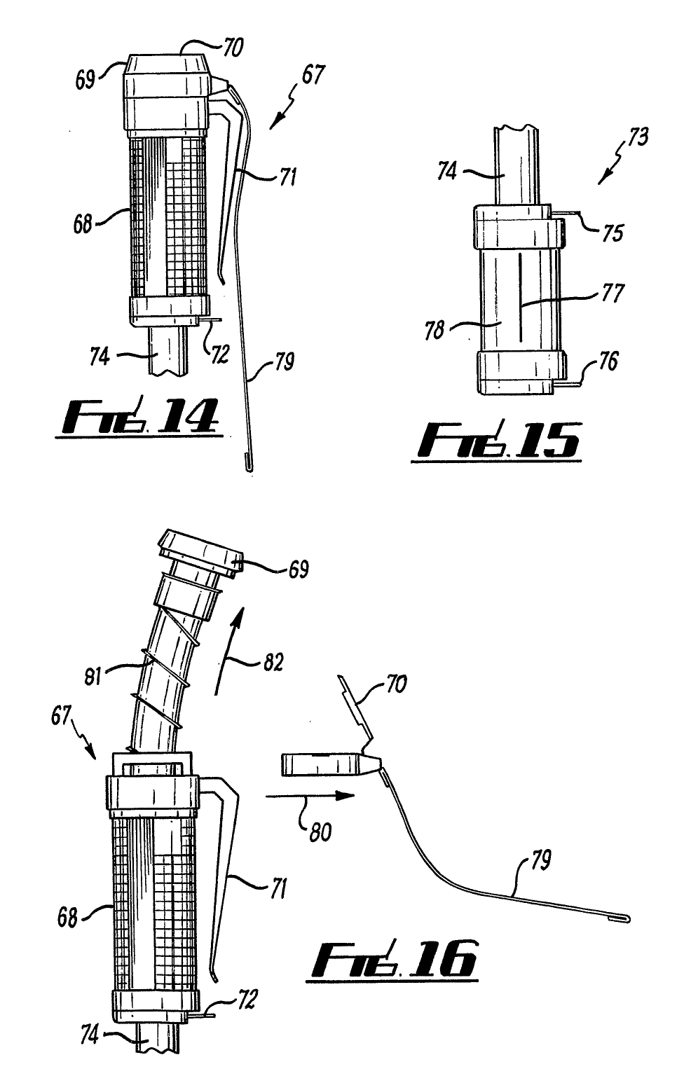

FIG. 15 illustrates in schematic form an alternative one way valve in accordance with an aspect of the present invention;

FIG. 16 illustrates in schematic form the alternative mouthpiece construction of FIG. 14 in an extended position in accordance with an aspect of the present invention;

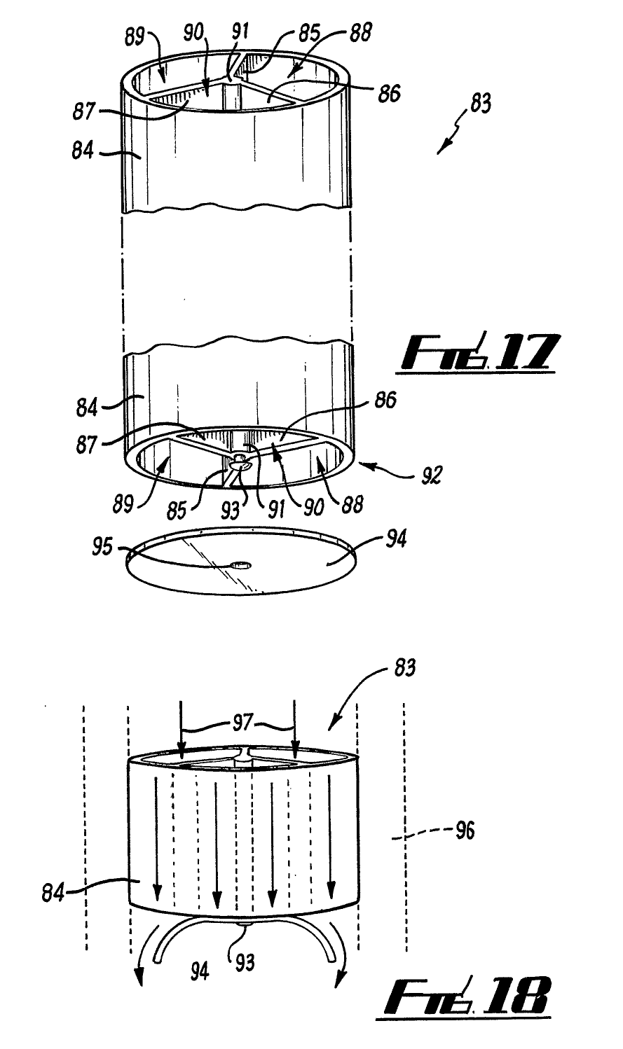

FIG. 17 illustrates in schematic form yet another alternative one way valve in accordance with an aspect of the present invention;

FIG. 18 illustrates in schematic form the one way valve of FIG. 17 in use;

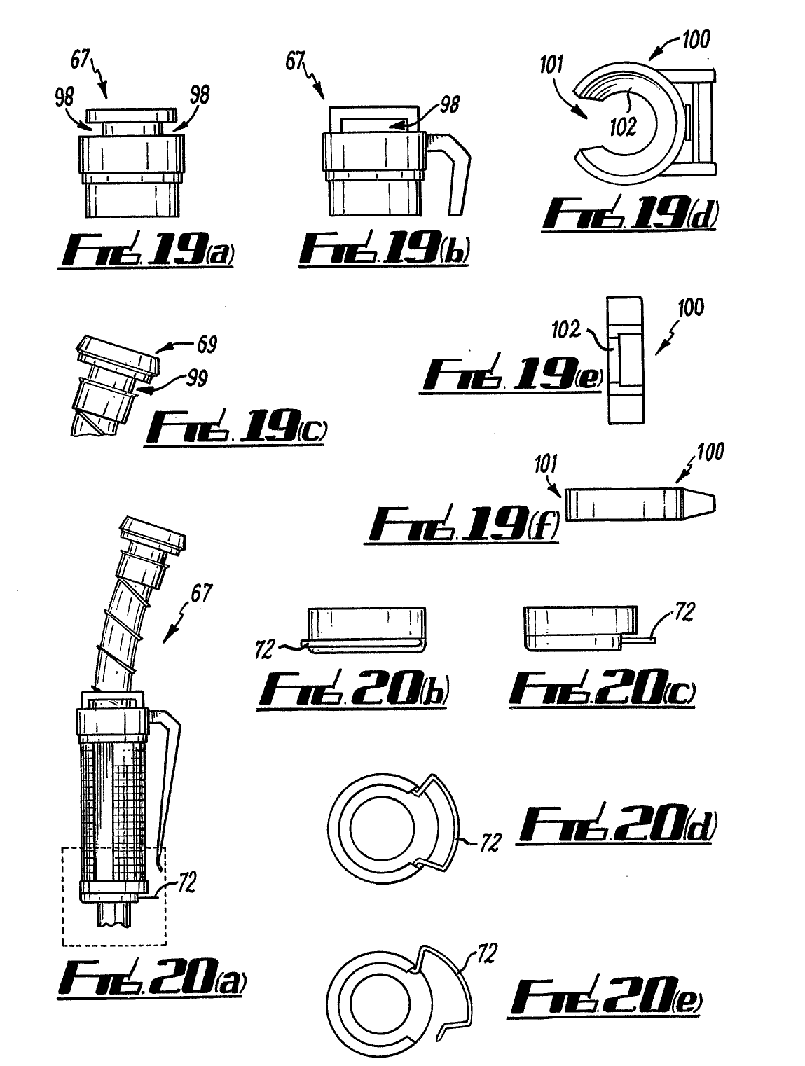

FIG. 19 illustrates in schematic form further detail of the cap shown in FIGS. 14 and 16;

FIG. 20 illustrates in schematic form further detail of the pin shown in FIGS. 14 and 16;

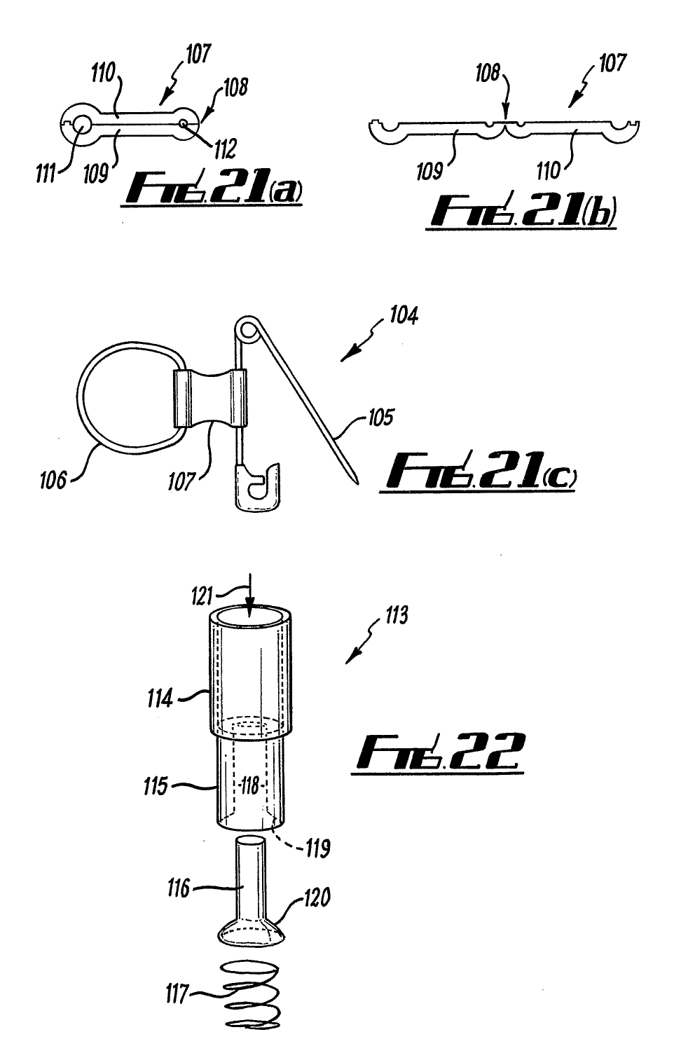

FIG. 21 illustrates in schematic form an alternative attachment means for attaching a tube to an item of clothing; and

FIG. 22 illustrates another alternative valve suitable for locating in the conduit of an emergency breathing apparatus in accordance with an aspect of the present invention.

With reference to FIGS. 1 to 3, there is presented a ski pole 1 that functions as an emergency breathing apparatus as described in detail below. The ski pole 1 comprises a handle 2 at the proximal end, an elongate body 3 and a tip section 4 at the distal end. A hollow channel 5 extends through the body 3 from the handle 2 to the tip section 4. Three circular handle apertures 6 provide fluid communication with the channel 5 at the proximal end 7 of the ski pole 1, and a circular tip aperture 8 provides fluid communication with the channel 5 at the distal end 9 of the ski pole 1. Thus, a fluid flow may be established between the handle apertures 6 and the tip aperture 8. A strap 10 is attached to the handle 2 to prevent loss of the ski pole 1 in the event of a fall. In the present invention it also prevents loss of the ski pole 1 in the event of an avalanche.

On the tip section 4 is located a circular basket 11 which, when in use as a conventional ski pole, prevents the ski pole 1 from sinking too far into the snow. In the present invention, the basket 11 serves an additional purpose, to prevent the ingress of snow into the tip aperture 8.

It is also envisaged that a retractable or removable cover could be located over the tip aperture and retracted or removed in the event of being trapped in an avalanche.

In use, a skier carrying the ski pole 1 will use it for its primary function as a ski pole. However, in the event of an avalanche, the skier may be buried under a mass of snow. Attaching the ski pole 1 to the skier's wrist by means of the strap 10 means that the ski pole 1 is likely to have remained with the skier. It is possible that the handle 2 will therefore be near the face, and hence the mouth, of the skier. If the skier is trapped in an air pocket, he may expel breath through the ski pole 1 by placing his mouth over the handle apertures 6 and breathing out. This will reduce the amount of carbon dioxide accumulating in the air pocket and delay asphyxiation. If the skier is unlucky and is not trapped in an air pocket, the ski pole 1 may be used to allow two way communication between the skier and the surface or a nearby air pocket. The skier may be able to breathe by virtue of air present within the snow pack, in which case the ski pole 1 will divert warm breath (in addition to carbon dioxide) away from the skier's face which might otherwise cause snow to thaw and refreeze as a barrier of ice, ultimately suffocating the skier.

FIG. 4 illustrates an alternative embodiment in which the handle 2 is detachable from the body 3. In this embodiment the hollow channel 5 houses an extendable tube 12 which maintains the fluid communication between the handle apertures 6 and the tip aperture 8. The tube 12 is robust and flexible. This provides a more convenient method of deployment as it is unlikely that it will be possible to manoeuvre the entire ski pole 1 into a position suitable for breathing but as the handle 2 is much shorter it may be possible then to move the handle apertures 6 toward the mouth of the skier.

A further advantage is gained in that if the body 3 of the ski pole 1 is broken or otherwise damaged, the risk of fluid communication between the handle apertures 6 and the tip aperture 8 being compromised is reduced.

The handle 2 will ideally be fixed to the body 3 by means of a quick release fastening which will remain in place until actuated by the skier in the event of an emergency. When actuated, the handle 2 will detach from the body 3 to allow the skier to move it towards his face.

The extendable nature of the tube 12 is also ideal for ski poles that are extendable too, such as those commonly available in ski hire shops. The present invention may therefore also be deployed in extendable ski poles. The tube 12 should therefore be sized to allow full extension of the ski pole 1 as well as sufficient extension to allow the handle 2 to be moved to the face of a skier.

The circular tip aperture 8 illustrated in FIG. 1 and FIG. 3 may be replaced with a number of slot shaped apertures 13 which are less likely to become plugged with snow in use. Furthermore, a greater surface area may be available for expulsion of air without compromising the structural integrity of the ski pole 1.

FIG. 6 illustrates another alternative handle 2 in which a single handle aperture 6 positioned at the top of the handle 2 is connected with the hollow channel 5 via a one-way valve 14. This one way valve 14 may be most useful in the case where the skier is trapped in an air pocket and wishes to expel carbon dioxide out with the air pocket. The one way valve 14 will also prevent any water or snow which is able to enter the hollow channel 5 from being breathed in by the skier which might cause respiratory problems. In the embodiments described above with three handle apertures 6, the one way valve 14 will ideally be located beneath the apertures 6, perhaps within the body 3 itself or near the bottom of the handle 2. Alternatively, each aperture 6 could be provided with its own one way valve 14.

FIG. 7 illustrates a modified basket 15 which removes the need for apertures 8,13 in the body 3 of the ski pole 1. (However, it is envisaged that the modified basket 15 could be used in addition to apertures 8,13). The modified basket 15 comprises a number of thin slots 16 which extend from the hollow channel 5 to the outmost surface 17 of the basket 15. Again, these are unlikely to be plugged with snow any more than a sharp outwards breath would be able to displace. An optional one-way valve (not shown) may be deployed at the tip section 4 to prevent the ingress of snow or water.

Moving the handle 2 of the ski pole 1 towards the face may be problematic if the snow is well packed around the skier—substantially limiting his movement. The embodiment of FIG. 8 serves to assist a trapped skier in maneuvering a set of apertures towards the skier's face to provide breathing via the ski pole 1.

The ski pole 1 illustrated in FIG. 8(a) comprises a modified handle 2 having a release mechanism 18 and a hinge 19 such that the top portion 20 of the handle can be separated from the bottom portion 21. The bottom portion 21 comprises a cavity 22 within which an extendable tubing section 23 is housed. Ideally, this is spring loaded such that upon separating the top portion 20 from the bottom portion 21 the tubing section 23 is forcibly extended from the bottom portion 21. A mouthpiece 24 having three apertures 6 is located at the end of the tubing section 23 to allow the skier to breathe through the pole 1 via the hollow channel 5. One-way valves may be disposed within the ski pole 1 in accordance with any of the previously described embodiments.

Alternatively, the ski pole 1b illustrated in FIG. 8(b) comprises a modified handle 2b in which the release mechanism 18b causes the mouthpiece 24b to pop upwards out of the top portion 20b.

In another alternative embodiment the top portion is completely detachable from the bottom portion, which may be achieved again by a release mechanism or by unscrewing or any other mechanical separation means.

FIG. 9 illustrates another alternative tip section 25 which comprises a first 26 and a second 27 tip aperture, separated by a longitudinal spacing. In this embodiment the apertures 26,27 are again located above the basket (not shown) but the slit valve 28 which is located within the tip section 25 prevents the apertures 26,27 from clogging. The slit valve 28 is a latex, neoprene (or other suitable material which is flexible and has a degree of resilience) cylinder 29 with a slit 30 which allows air to flow through but prevents the ingress of fluid or snow. Furthermore, it prevents the user from breathing in through the valve 28. It is foreseen that a further one-way valve be located prior to the slit valve 28.

FIG. 10 illustrates a pop-out mouthpiece construction 31. It comprises a threaded, hollow, cylindrical body member 32 with a cylindrical moveable member 33 forming an interference fit within the body member 32. A mouthpiece aperture 34 is located topmost on the moveable member 33 and allows connection of a mouthpiece 35 to a tube 36 therethrough.

A release catch 37 is formed by a substantially rectangular catch plate 38 and a perpendicularly extending push plate 39. The catch plate 38 and push plate 39 are preferably formed from a single piece of material with a 90° bend forming the push plate. An ovoid aperture 40 allows the mouthpiece 35 to be located through the catch plate 38.

The mouthpiece has an annular slot 41 into which the edge 42 of the ovoid aperture 40 may locate. The catch plate 38 is resiliently biased into such a position by a spring 43 located in a spring aperture 44 and engaging the inner surface of the push plate 39. A pin 45 located in pin aperture 46 serves as a limiter and a guide for the catch plate by cooperating with an associated guide slot 47.

A large spring 48 biases the mouthpiece 35 toward an extended position when the push plate 39 is pushed toward the pin 45, thus disengaging the edge 42 from the annular slot 41. A removable cap 49 covers and protects the mouthpiece 35 until it is required. Thus, pushing the push plate 39 causes the mouthpiece to pop out of the top of the mouthpiece construction 31.

FIG. 11 illustrates an alternative pop-out mouthpiece construction 50. This comprises a cylindrical body member 51 with a mouthpiece member 52 slidably located within. Similarly to that of FIG. 10 above, a large spring 53 biases the mouthpiece member 52 to an extended position away from and out of the body member 51. If the body member 51 is fixed in position, an extension of the mouthpiece member 52 draws the tube 54 up through the body member 51 as required.

The mouthpiece member 52 is retained (with the spring 53 in a compressed position, illustrated) by means of a circular clip 55 which locates in and engages with an annular slot 56 on the mouthpiece member 52. An appropriately sized aperture 57 on the body member 51 allows the clip 55 to pass therethrough and be held in position.

Either mouthpiece construction 31,50 of FIG. 10 and FIG. 11 may be deployed on the end of a ski pole. Alternatively, and as illustrated in FIG. 12, the mouthpiece constructions 31,50 may form a mouthpiece 58 which connects to a tube 59 located through an item of clothing, in this example a jacket 60. A one way valve 61 is located at the opposite end of the tube 59 to facilitate exhalation of air through the tube 59.

FIG. 12b illustrates a slightly different embodiment of a jacket 60b through which a tube 59b extends. Mouthpiece 58b, which may take the form of the mouthpiece construction of FIGS. 14 to 16, is located in the collar of the jacket 60b and the vertical alignment of this embodiment will direct a pop-out mouthpiece (again as discussed below with reference to FIGS. 14 to 16) towards the mouth of the user wearing the jacket 60b.

Referring to FIG. 11, a tab portion 51b may be located on the body member 51 to allow the mouthpiece construction 50 to be affixed to an item of clothing, for example when fed into an appropriately sized hole in a jacket, the tab can be sewn into the fabric to fix the mouthpiece construction firmly in place.

With reference to FIG. 13, a further suitable tube 62 may also be located through the lining of a pair of trousers 63 (or salopettes) and adapted to connect via connectors 64,65 to the end of a tube 59 located through a jacket 60. In this case the one-way valve 61 is located at the bottom of one of the legs of the trousers 63. The mouthpiece 58 is in this case located at the cuff 66 of one of the sleeves to make movement of the mouthpiece 58 to a user's mouth as easy as possible.

In this way, when both items are being worn, and both tubes connected, the wearer may exhale to a location near his feet.

FIGS. 14 to 16 illustrate a yet further alternative embodiment of the present invention. The mouthpiece construction 67 comprises a cylindrical body 68 with a mouthpiece 69 and a cap 70 holding the mouthpiece 69 in a compressed position (shown in FIG. 14) and covering the top of the mouthpiece 69 to prevent snow ingress. A clip 71 and a pin 72 provide means of attaching the mouthpiece construction 67 to an item of clothing.

Valve construction 73, connected to the mouthpiece construction 67 by way of air tube 74, is also provided with attachment means, in this case two pins 75,76 which can be used to fix the valve construction 73 to an item of clothing. The valve construction 73 is substantially cylindrical, with a slit 77 formed on a flexible outer surface 78. The slit 77 acts as a one way valve, the flexible nature of the outer surface 78 allowing the slit 77 to expand to allow expression of air exhaled through the tube 74.

In use, the mouthpiece construction 67 may be located on a skier's jacket, say, on the collar. The air tube 74 can run down within the jacket and around to the back where it is connected to a valve construction 73, which is pinned to the outside of the jacket to the user's rear.

In an emergency, the user removes the cap 70 by pulling on lanyard 79 (in the direction of arrow 80) which is attached to the cap 70. A spring 81 which is biased against the compressed position (FIG. 14) then propels the released mouthpiece 69 away from the body 68 of the mouthpiece construction 67 in the direction of arrow 82).

FIG. 17 presents an alternative valve 83 which can replace, for example, the valve construction 73 shown in FIG. 15. The valve 83 comprises a substantially hollow valve member 84, which in this example has three walls 85,86,87 defining three channels 88,89,90 and a central column 91. At a distal end 92 of the central column 91 is located a stud 93. A flexible disc 94 with a hole 95 sized to accept and locate on the stud 93 is provided, the disc 94 sized to cover all three channels 88,89,90.

In use, as illustrated in FIG. 18, the valve 83 is located within an air pipe 96 with the flexible disc 94 positioned at the end distal from the user's mouth. When the user breathes out, air flows down the pipe in the direction of arrows 97, through the channels 88,89,90 until it meets the flexible disc 94. The flexible disc 94 then flexes about the stud 93 to allow exhaled air to pass. If the user attempts to breathe in or suck on the tube, the flexible disc 94 returns to its normal position, the negative pressure maintaining a seal between the disc 94 and the hollow valve member 84. This valve could be located within the mouthpiece construction itself, which would permit attachment to any conduit to achieve a breathing apparatus in accordance with the invention.

An alternative one way valve which could function in a similar manner to the flexible disc embodiment might make use of a ball-valve—the ball moveable between a position where it blocks fluid flow toward the user's mouth and a second position permitting fluid flow from the user's mouth in the opposite direction.

Further details of some of the component parts of FIGS. 14 to 16 are now discussed. FIGS. 19a and 19b show two orthogonal side views of the top of a mouthpiece construction 67, as well as (FIG. 19c) the pop-out mouthpiece 69 itself. Grooves 98 on either side of the top end of the mouthpiece construction 67 correspond with a circumferential groove 99 on the mouthpiece 69 when in a compressed position. The cap 100, illustrated in a top view (FIG. 19d), an end on view (FIG. 19e) and a side view (FIG. 19f), takes the form of a “C” clip, the open end 101 of which allows an engaging portion 102 of the “C” clip to engage the circumferential groove 99 of the mouthpiece 69 via the grooves 98 on the mouthpiece construction 67 thus holding the mouthpiece 69 in place.

FIG. 20 illustrates in further detail the pin 72 at the lower end 103 of the mouthpiece construction 67 of FIGS. 14 to 16. Shown are two orthogonal side views (FIG. 20b and FIG. 20c) and two top views with the pin closed (FIG. 20d) as it would be once affixed to, say, an item of clothing; and with the pin open (FIG. 20e) ready for attachment.

FIG. 21 illustrates an attachment device 104 comprising a pin 105 and a loop 106 joined by an attachment clip 107. The attachment clip 107 comprises a hinge 108 joining a first 109 and a second 110 clip section which are shaped such that when they are joined (FIG. 21a) a first channel 111 and a second channel 112 are formed which retain the loop 106 and the pin 105 respectively. The pin 105 can be used to fixedly attach the attachment device 104 to, say, an item of clothing and a tube can be threaded through the loop 106 such that it may be held in place and/or guided along a preferred path.

Finally, FIG. 22 illustrates another one way valve 113 for locating within a conduit 114. The valve 113 comprises a valve housing 115, a valve member 116 and a spring 117. The valve housing 115 has a bore 118 extending therethrough which has an outwardly tapering surface 119 which matches a corresponding tapered surface 120 on the valve member 116.

In use, the valve member 116 is held against the valve housing 115 under the force of the spring 117. When the user exhales, expelling air in the direction of arrow 121, the increase in pressure forces the valve member 116 down against the bias provided by the spring 117. When this occurs, the air is able to escape between the tapered surfaces 119,120 of the valve housing 115 and valve member 116. When the user attempts to inhale, the valve member 116 is drawn back up into the valve housing 115, assisted by the bias of the spring 117, thus forming a seal.

Typically the spring 117 is a light spring, such as might be constructed by coiling a thin length of wire, preferably resilient enough to hold the valve member 116 against the valve housing 115 in a closed position when not in use but flexible enough to allow the valve to open when a user exhales.

It is envisaged that a further modification may be made to the ski pole or mouthpiece construction of any of the above described embodiments to incorporate a whistle. Optionally, the whistle would be integral to the breathing apertures or mouthpiece such that the whistle would sound while the trapped skier was breathing out. This would lead a search party to the skier more quickly, and also provide an external indicator of whether the skier was actually breathing. As the continual whistling may however distress or deter the skier from using the breathing apparatus properly, the whistle may be adapted to only sound when desired—one solution would be to provide a hole which preferentially allows exit of exhaled air through a whistling section but when covered diverts the exhaled air through the ski pole or attached tube or conduit.

The present invention also provides a mouthpiece construction and a corresponding conduit which can be retrofitted into an existing item of clothing or an existing ski pole. For example, the mouthpiece construction can be inserted into the lapel or cuff of a jacket, and a corresponding conduit fed through the lining of the jacket. A one way valve can be attached to the end of the conduit which emerges from the lining of the jacket near the bottom, or a connector to connect to a corresponding conduit which can be inserted through a pair of trousers. Alternatively, the one way valve can be located within the mouthpiece construction. In this way, to achieve the present invention any suitable conduit could be connected to the mouthpiece without the need for any modification to the conduit.

The present invention therefore not only allows a user to expel carbon dioxide away from his source of oxygen, but offers a cheap and convenient way of implementing this in existing equipment or clothing. This means that a skier or walker may benefit from the advantages of the present invention without having to carry additional, expensive, items of equipment. Also, it reduces significantly the risk that the user will forget to take the breathing apparatus.

Referring once more to “Avalanche Survival Chances”, the mean depth of burial under the snow of the skiers found dead on extrication was 105 cm. This is approximately the length of a ski pole, and so the benefits of the present invention with regards to providing valuable minutes of breath are therefore painfully obvious.

Although more rapid searching and recovery of avalanche victims is still required, use of the ski pole or of the mouthpiece and conduit located in an item of clothing of the present invention may mean the difference between life and death; preventing oxygen starvation by removing carbon dioxide which would otherwise remain in the vicinity of the victim.

Further modifications and improvements may be added without departing from the scope of the invention as defined by the appended claims. For example, where examples have been illustrated with regard to ski poles, it is envisaged that hillwalkers or mountain climbers may also enjoy the benefits of the present invention by incorporating the inventive features into walking poles which share many of the important features of ski poles.

1. An emergency breathing apparatus for skiers trapped in an avalanche, the emergency breathing apparatus comprising:
a conduit comprising a substantially hollow channel having a proximal end and a distal end and adapted to provide fluid communication therebetween; and
a mouthpiece construction comprising a body member and a mouthpiece member;
the mouthpiece member in fluid communication with the proximal end of the conduit and moveable between a compressed position where it is located at or near the body member and an extended position where it is located away from the body member.

2. (canceled)

3. An emergency breathing apparatus as claimed in claim 1, comprising a one way valve adapted to restrict fluid flow in one direction through the hollow channel.

4.-6. (canceled)

7. An emergency breathing apparatus as claimed in claim 3, wherein the one way valve comprises a flexible disc adapted to flex to permit fluid flow in one direction and to form a seal against fluid flow in an opposing direction.

8. An emergency breathing apparatus as claimed in claim 3, wherein the one way valve is a ball valve comprising a ball moveable between a first position permitting fluid flow in one direction and a second position forming a seal against fluid flow in an opposing direction.

9. An emergency breathing apparatus as claimed in claim 3, wherein the one way valve comprises a valve member having a tapered surface and a valve housing having a corresponding tapered surface, the valve member moveable between a first position permitting fluid flow in one direction and a second position in which the tapered surfaces engage forming a seal against fluid flow in an opposing direction.

10.-75. (canceled)

76. An item of clothing comprising a breathing apparatus according to claim 1, wherein the conduit extends substantially through the item of clothing.

77.-82. (canceled)

83. An item of clothing as claimed in claim 76, wherein the conduit comprises a connection means located at a lower end of the item of clothing, adapted for connection to a second item of clothing having a second conduit extending therethrough.

84. (canceled)

85. (canceled)

86. A breathing apparatus as claimed in claim 1, wherein the mouthpiece member is biased toward the extended position.

87. A breathing apparatus as claimed in claim 1, wherein the mouthpiece member is held in the compressed position by a releasable catch.

88. A breathing apparatus as claimed in claim 87, wherein the releasable catch comprises a snap clip adapted to cooperate with one or more corresponding grooves on the mouthpiece member.

89. A breathing apparatus as claimed in claim 87, wherein the releasable catch is resiliently biased in a closed position when the mouthpiece member is in the compressed position.

90. A breathing apparatus as claimed in claim 87, further comprising a lanyard which is connected to the releasable catch.

91. A breathing apparatus as claimed in claim 87, further comprising a cap which is adapted to removeably seal the mouthpiece member and which is integral to the releasable catch.

92. A breathing apparatus as claimed in claim 91, wherein the cap comprises a soft material so as to be removeable by biting.

93. An emergency breathing apparatus as claimed in claim 3, wherein the mouthpiece construction comprises the one way valve.
